(19) United States
(12) Patent Application Publication
(10) Pub. No.: US 2013/0254292 A1
(43) Pub. Date: Sep. 26, 2013

(54) STORY CONTENT GENERATION METHOD AND SYSTEM

(71) Applicant: AUTHORBEE, LLC, Ridgefield, CT (US)

(72) Inventor: Stephen T. Bradley, Ridgefield, CT (US)

(73) Assignee: AuthorBee, LLC, Ridgefield, CT (US)

(21) Appl. No.: 13/848,701

(22) Filed: Mar. 21, 2013

Related U.S. Application Data
(60) Provisional application No. 61/613,625, filed on Mar. 21, 2012.

(51) Int. Cl. H04L 29/06

(52) U.S. Cl. CPC H04L 65/403
USPC 709/204

(57) ABSTRACT

A computer-assisted system and method for the creation, organization, consumption and distribution of bodies of user-generated content. The system and method includes joining individual contributions, made both synchronously and asynchronously, by multiple user contributors in real-time to form the content. The system and method implements a non-destructive approach, with each individual contribution made by every contributor being maintained as a complete, distinct entry, and retaining its original presence in the work without being subject to modification, deletion, obsolescence or replacement.

### CROSS REFERENCE TO RELATED APPLICATIONS

This application claims the benefit of U.S. Provisional Application Ser. No. 61/613,625, filed Mar. 21, 2012, the contents of which are incorporated by reference herein in their entirety.

### BACKGROUND OF THE INVENTION

1. Field of the Invention

The present disclosure is related to story content and other digital media content. More particularly, the present disclosure is related to systems and methods that provide for multiple contributors to collaboratively generate works and other media content.

2. Description of Related Art

Works such as, but not limited to, stories, books, articles, music, lyrics, plays, movies, and others, are often generated by content from more than one contributor (or “author”). Here, the contributors collaborate to generate a single work by modifying and revising one another's content. In some instances, the previous drafts are maintained as unique content, but are left unused when the work is finalized.

The use of social media such as Facebook, MySpace, Google+, Linkedln and other similar systems is becoming more and more prevalent in various realms of daily life.

The present disclosure is related to a social media system and method that allows multiple contributors to work on the same body of content, but allows each contributor, and even each consumer of the content, to generate their own unique path through the body of content, and to capture that unique path in the creation of a completed work.

### BRIEF SUMMARY OF THE INVENTION

A computer-assisted system and method for the creation, organization, consumption and distribution of bodies of user-generated content. The system and method includes joining individual contributions, made both synchronously and asynchronously, by multiple user contributors in real-time to form the content.

The system and method of some embodiments allow for a high degree of collaboration and cooperation between participating parties, both contributors and consumers, in the creation of any single body of work, with the participants enabled to determine, through their contributions and interactions with the system and method and each other, how each of their component contributions will be integrated into the work such that it may be consumed, published, sold, used, distributed and/or otherwise enjoyed by both consumers of, and other contributors to, the work.

Additionally, the system and method of some embodiments implement a non-destructive approach, with each individual contribution made by every contributor being maintained as a complete, distinct entry, and retaining its original presence in the work without being subject to modification, deletion, obsolescence or replacement.

Further, the system and method of some embodiments combine contributions from multiple parties into different groupings and/or sequences for the purpose of creating valuable or otherwise pleasing “completed works” as a result of such combination.

Also, the system and method of some embodiments incorporate individual contributions into a single body of work, using multiple groupings and sequences with other individual contributions, to form multiple completed works, each of which represents a different and unique “view,” or path, through the total body of work.

Still further, the system and method of some embodiments allow individual contributions to be developed and contributed from, and to be consumed and enjoyed by users upon, multiple hardware and software platforms, including but not limited to web-based, mobile and social networking platforms.

In another embodiment, a computer-assisted system and method for the creation, organization, consumption and distribution of a body of user-generated content is provided. The resultant work includes individual contributions submitted from multiple user participants, allowing combination and consumption by other user participants whereby each individual user may define his/her own unique combination of contributions that may make a finished “completed work product” from the total body of work.

The system and method of some embodiments allow users to self-direct the navigation of multiple linear paths through such body of work; and further allowing any number of such linear paths to co-exist through the single body of work, with each unique path representing a potential or actual “completed work,” based on the perspective of each individual user/consumer of the content.

Additionally, the system and method of some embodiments accommodate any number of individual contributions made from any number of individual contributors, where contributions will be connected together in multiple sequences, with each sequence representing a unique configuration (or “path”) of connected contributions throughout the body of work. Contributors may append new contributions to any contribution at any point in any sequence, without destroying or modifying the existing sequence or its contents, thereby creating a new, unique sequence or path through the body of work that they or another user may follow.

Further, the system and method of some embodiments allow each individual contribution (or “segment”) to be appended to, at most, one “parent” segment; whereas each segment may have an unlimited number of “child” segments appended to it. Every ending segment in any chain—in this case, every segment that has no “child” Segment appended to it—at any point in time, represents one of potentially many unique “storylines” within the total body of work, tracing its way back to some beginning segment in a single, unique, linear path.

It should be recognized that the present disclosure is described by way of example only where every segment has at most one parent segment. This allows for easy description, tracking and management of unique storylines. However, it is also contemplated by the present disclosure that a segment may have more than one parent segment. Every case where a segment has more than one parent segment can also be described and managed as an equivalent case where each segment has only one parent, by considering the multi-parent segment as multiple instances, copies or clones of the original segment.

Further, the system and method of some embodiments allow users to make copies of segments or chains of segments, and to attach those copies to any other segment in the body of work.

In yet another embodiment, a computer-assisted system and method is provided that prioritizes multiple, unique combinations and sequences of user-generated content contributed by multiple user participants into a single body of work.

The system and method of some embodiments prioritize and manage the available segment sequences based upon either a) universally defined criteria for all consumers of a body of work, and/or b) the individual preferences, profile and/or actions of each individual user-consumer.

Additionally, the system and method of some embodiments allow each participant (consumer or contributor) to be presented with his/her own optimized “view” into a given body of work, wherein two different consumers of the work, each approaching the work for the first time, may be presented with two entirely different “views” of the same work, with each view based upon the individual consumer's profile, preferences and interactions.

Also, the system and method of some embodiments allow the algorithms for the prioritization of “views,” or paths, through the body of work to be flexible and limited only by the amount of information known about each user.

Further, the system and method of some embodiments allow each individual consumer of the content or user to refine and/or modify the algorithms selectively in order to see different views of, or paths through, the body of work, including navigating the content paths step by step, choosing each step from the existing connections available, or by establishing new connections and content of their own.

The system and method of some embodiments allow for the capture, contribution and management of “meta-information” (i.e., information about or otherwise related to, but not itself, the core segment content) within each individual segment. This meta-information may include additional text or other digital media that has been contributed or linked from publicly accessible sources, either by the original contributor of the segment, by any other user of the system, or by the system itself.

Additionally, the system and method of some embodiments may optionally incorporate a method and procedure for tracking, evaluating, comparing and weighing the relative contributions made by multiple contributors in any subset of the total body of work (the “attribution engine”). Such an attribution engine would be used to define, monitor and manage the relative contributions of multiple contributors involved in any defined sub-set of the total body of work.

Further, the system and method of some embodiments allow for the allocation of any potentially available reward and/or recognition associated with a work to the multiple contributors involved in contributing to that work, based on the attribution engine.

Further, the system and method of some embodiments allow for the incorporation of user reviews and ratings (of individual and aggregate user contributions, and of their contributors) as inputs to the attribution engine.

Additionally, the system and method of some embodiments allow for the development of templates or frameworks that may be used either to direct, guide or evaluate user contributions, both in real-time (as the user is creating and submitting a new contribution) and after a user contribution has been submitted.

Further, the system and method of some embodiments allow such templates, or frameworks, to be defined both globally and/or locally specific to any story, contribution or contributor.

Further, the system and method of some embodiments allow such templates, or frameworks, to be defined by individual users of the system.

Further, the system and method of some embodiments allow such templates, or frameworks, to be made available for re-use by other users of the system

The system and method of some embodiments allow for the ability to make available various forms of compensation, recognition or attribution in connection with a user's re-use of an available template, or framework.

The system and method of some embodiments also allow for the use of such templates, or frameworks, in the evaluation and prioritization of multiple segment chains that may be available for presentation by the system to a user at any point. Such evaluation and/or prioritization may be defined globally within the system or within a story, or may be defined locally by either the individual user or the individual creator of the associated template, or framework.

The system and method of some embodiments allow for the automated generation of sequential chains of user-contributed segments (“system-generated storylines”) based on an evaluation of the available segments and/or the creation and inclusion of new system-generated segments, in reference to such templates, or frameworks, and/or any other available set of rules as may be determined for the purpose.

Accordingly and as used herein, the term “segment” shall mean an encapsulated unit of content and/or data, including but not limited to text, audio, video, images, drawings, data or other representations or media. The term “storyline” shall mean a particular path through the available segments, where the path is defined by linking segments to one another in a particular order. The term “story” shall mean a collection of related data and content elements including but not limited to segments and storylines. The term “meta-information” shall mean any information about or related to a segment, a storyline, a story or any combinations thereof including, but not limited to information about the contributors, type of content, when contributed, in what context contributed, relationship to other content and/or dynamic information about how the content is used and/or consumed by users, such as when read, liked, used or favorited by users.

The above-described and other features and advantages of the present disclosure will be appreciated and understood by those skilled in the art from the following detailed description, drawings, and appended claims.

### BRIEF DESCRIPTION OF THE DRAWINGS

FIGS. 1 through 29 illustrate an exemplary embodiment of the system and method according to the present disclosure in use with a sample story about Maxi's Balloon; and

FIG. 30 illustrates an exemplary embodiment of a system and non-transitory storage medium on which the method illustrated by FIGS. 1 through 29 is implemented.

### DETAILED DESCRIPTION OF THE INVENTION

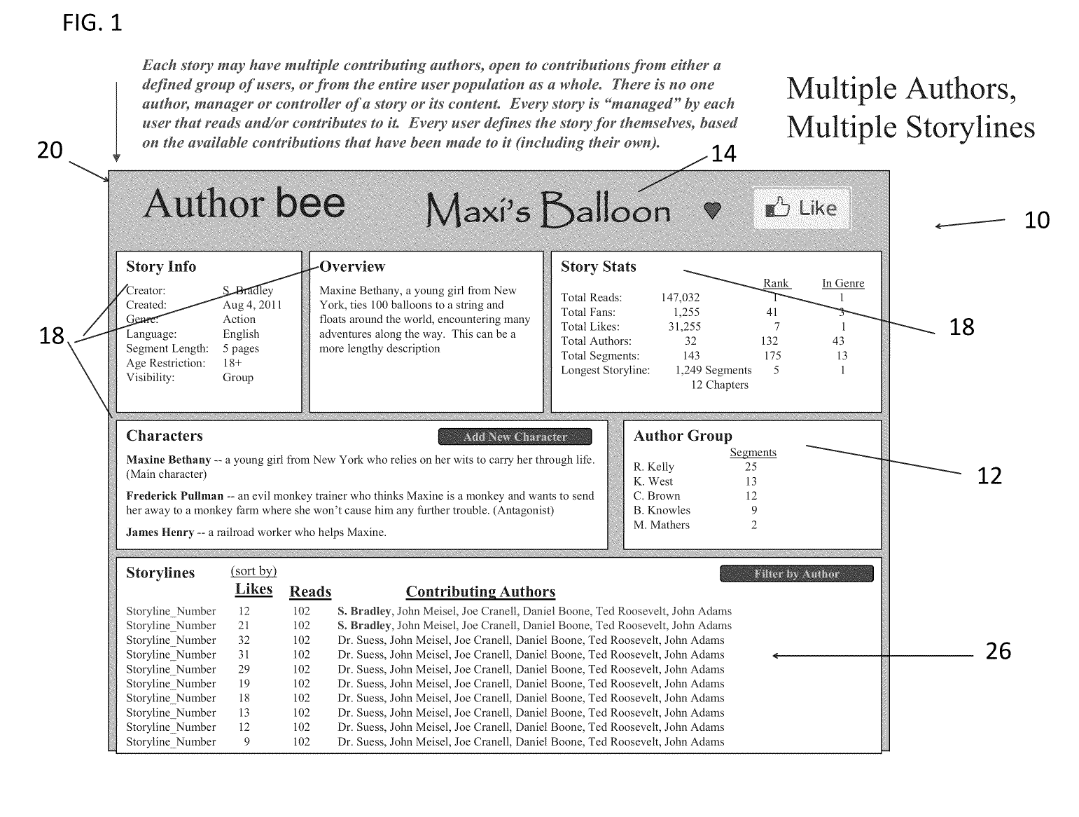

Referring to the drawings, an exemplary embodiment of the system and method 10 according to the present disclosure is shown. Method 10 is illustrated in FIG. 1 according to an exemplary embodiment of the present disclosure having a story presented to the user as an aggregation of user-contributed segments 12, including content elements, meta-data referring to those elements, and meta-data and other information connected with the aggregation of those elements (the “story”). Meta-data about the story includes, but is not limited to, a title 14, overview description 18, categorization (e.g., genre) 18, characters used in and statistics 18 about the story 20, including, the number of times the story has been read, “liked” and marked as a “favorite” by users of the system. Further, FIG. 1 shows how discrete available “storylines,” 26 or chains of user-contributed segments 22, appear in connection with the story 20, including individual statistics (such as those referred to above) and the list of contributing contributors associated with each available storyline 26.

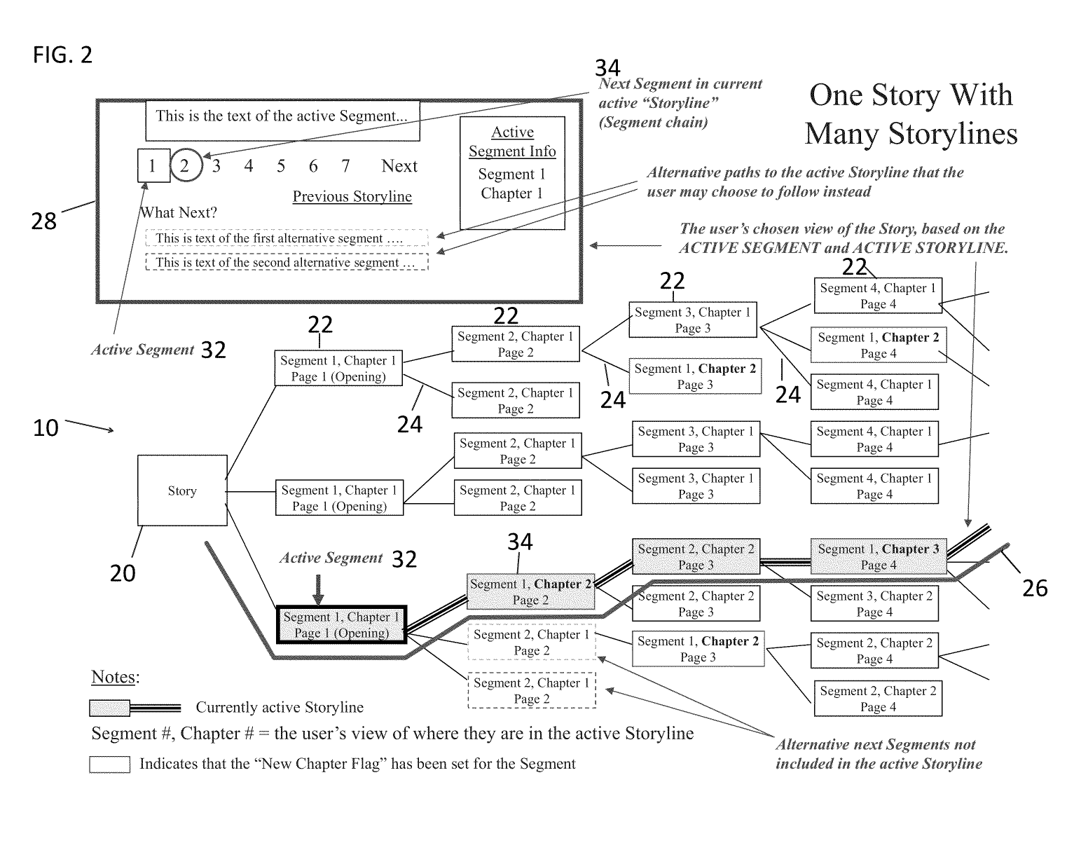

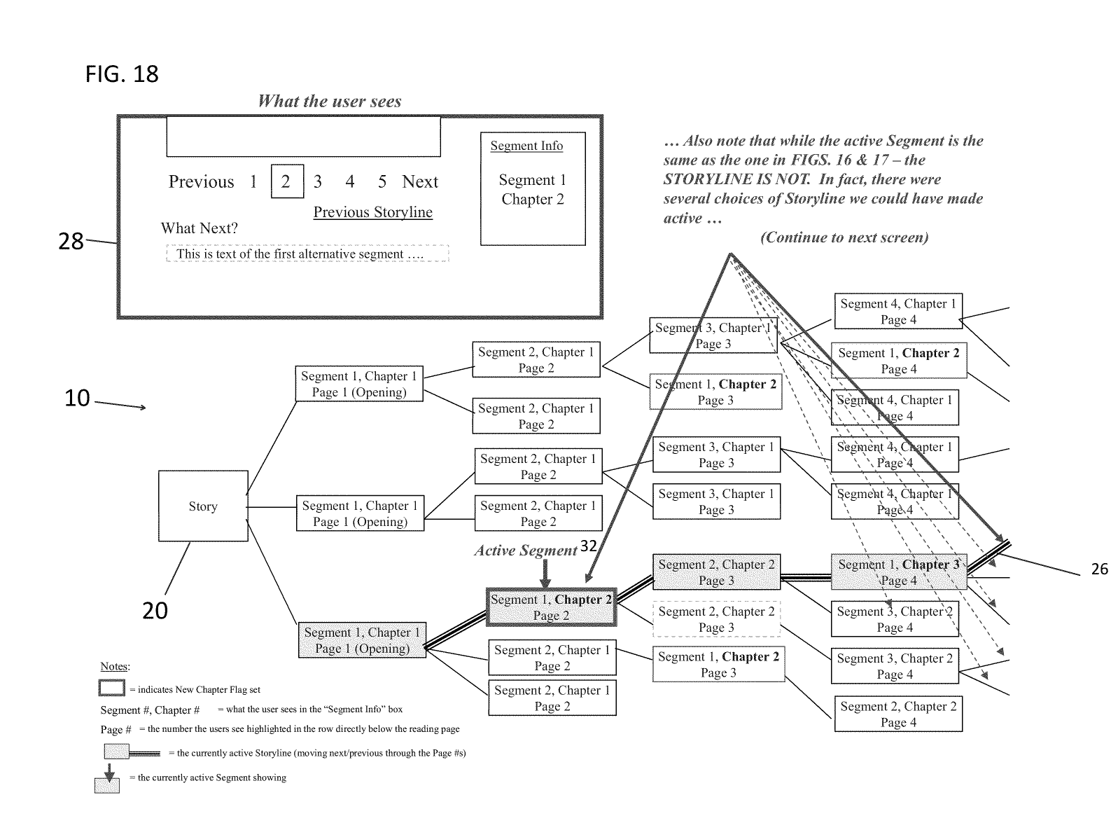

FIGS. 2 through 29 show a graphic representation for how the individual user-contributed segments are chained together in an exemplary embodiment within the overall context of a story 20 in the system or method 10 of the present disclosure.

FIG. 2 begins by showing an available network of segments 22 all associated with a single story 20, and the linkages 24 between them. Each unique path represents a unique or different “storyline” 26 within the story 20. As seen in FIG. 2, for a given user at any given point in time, exactly one segment 22 and one unique storyline 26 will be “active” within the system (indicated by the segment outlined in bold 32, and the heavy lines connecting a single chain of segments 26, respectively). Further, the upper left box 28 in the FIG. 2 shows how the active state of the system 10 might be represented to the user, with the text, media elements and meta-information associated with the currently active segment 32 visible to the user, along with navigation information that would allow the user to progress forward or backward through the currently active storyline 26, or to select from among available alternative or next segments 34 inside or outside of the active storyline 26 as they progress through the story 20.

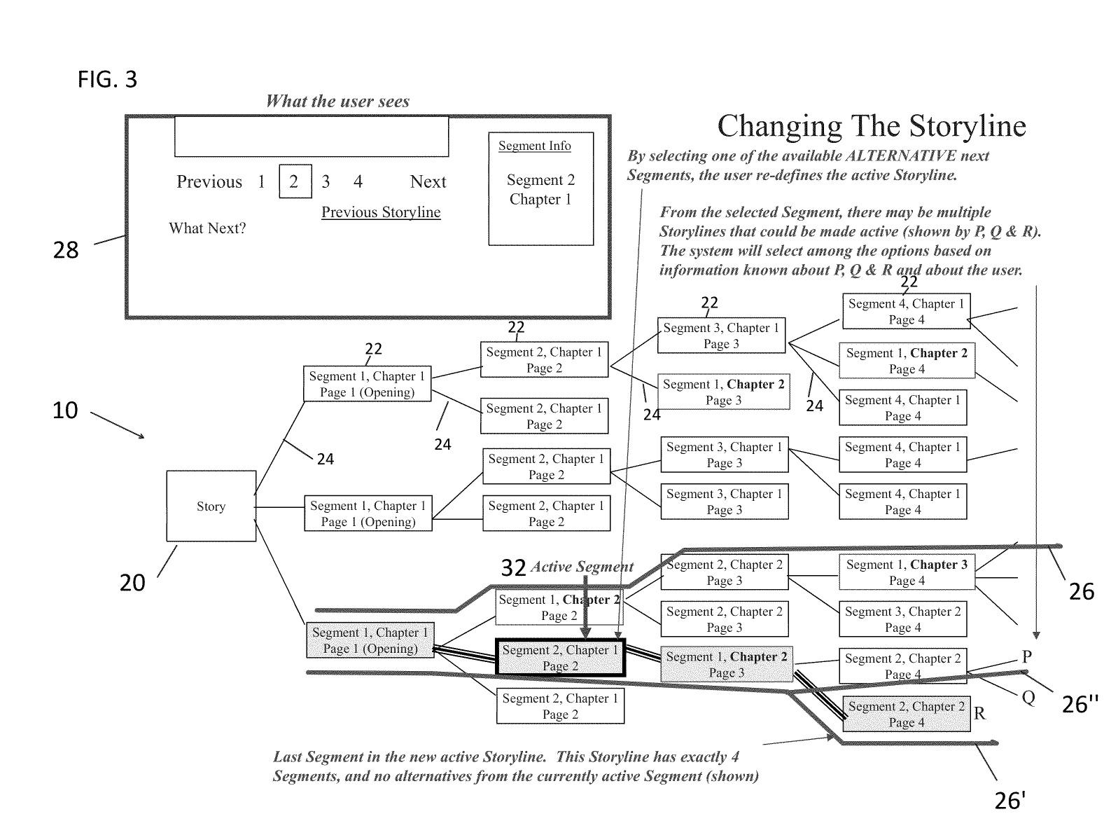

FIG. 3 illustrates, in comparison to FIG. 2, how the user may use system 10 to make a new unique storyline 26′ active by selecting one of the available alternatives to any segment 22 in the prior active storyline 26 at any point. Further, FIG. 3 illustrates that there may be multiple unique storylines 26′, 26″ extending from the newly selected “active segment” 32 chosen by the user, in which case the system will prioritize which of the possible storylines to make “active” in connection with the new segment 22 the user has selected (this prioritization would be based on methods described above).

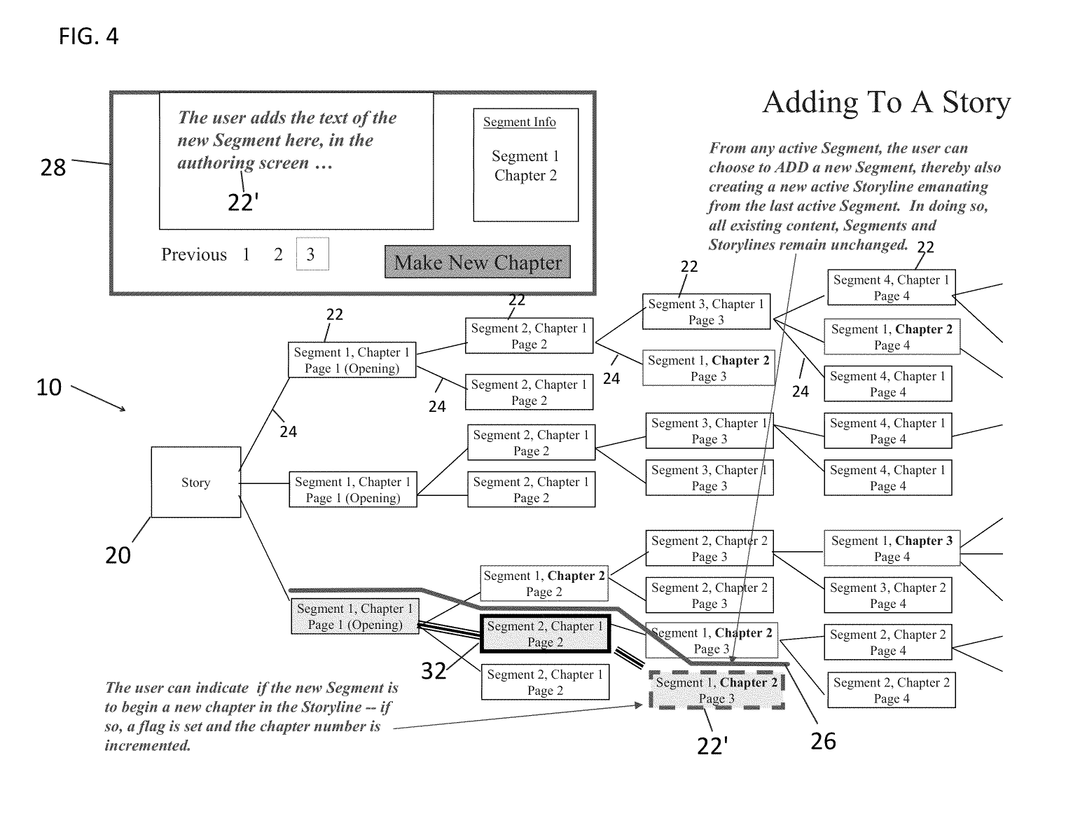

FIG. 4 illustrates that a user may use system 10 to additionally choose to add a new segment of his/her own creation at any point in the active storyline 26, with such new segment 22′ being appended to the currently active segment 32.

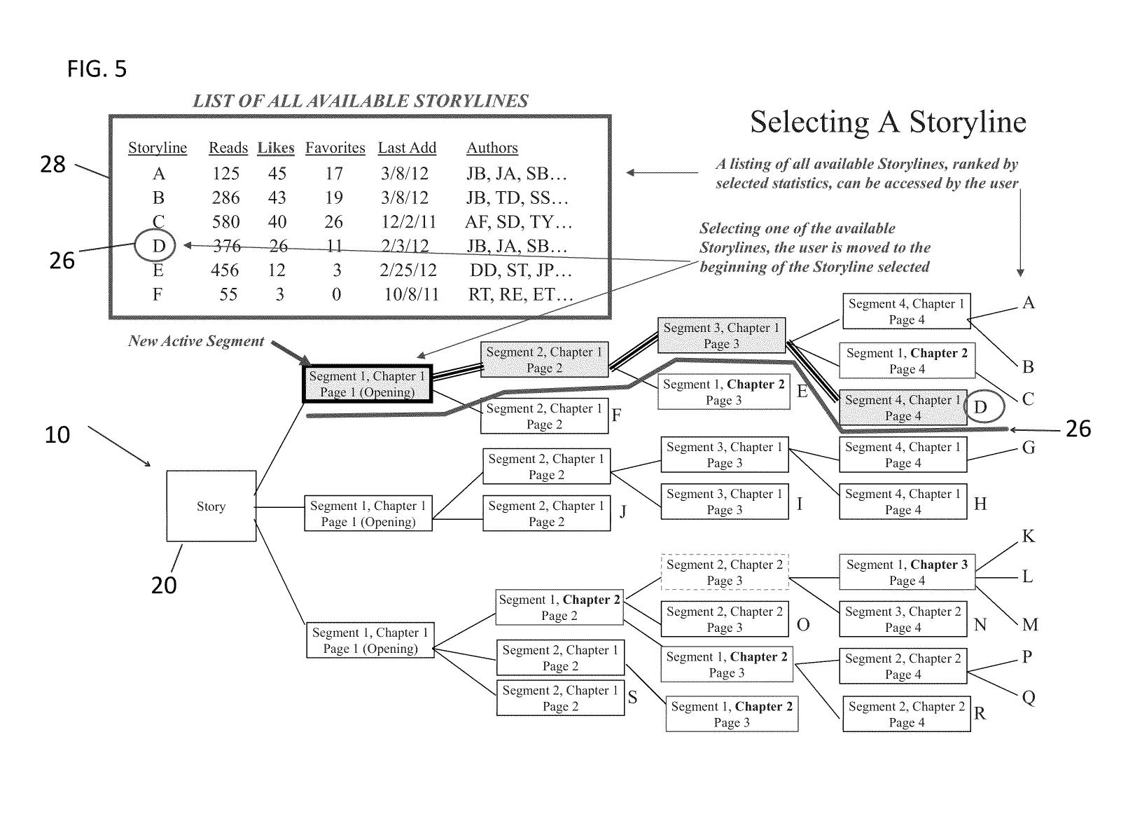

FIG. 5 illustrates, system 10 having letters (A through S) next to the boxes in the graphic, each chain of segments 22 in the story 20 that is considered a unique storyline 26. FIG. 5 further illustrates, by the box 28 in the upper left and the circled letters, how an available storyline 26 might correspond to the user's view of that storyline 26 as shown in FIG. 1.

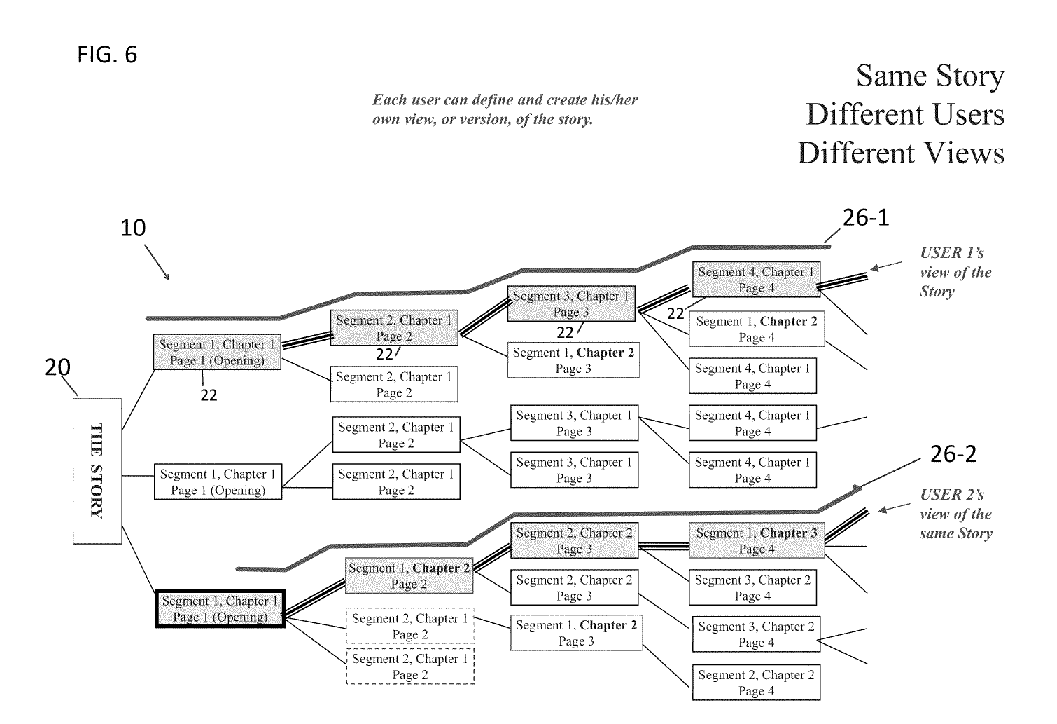

FIG. 6 illustrates that each user of the system 10 is able to define his/her own version, or “view,” of the same story 20, as defined by the unique storyline 26, or chain of segments 22 through the story, selected by the user. Here, two different storylines 26-1 and 26-2 are illustrated for different users.

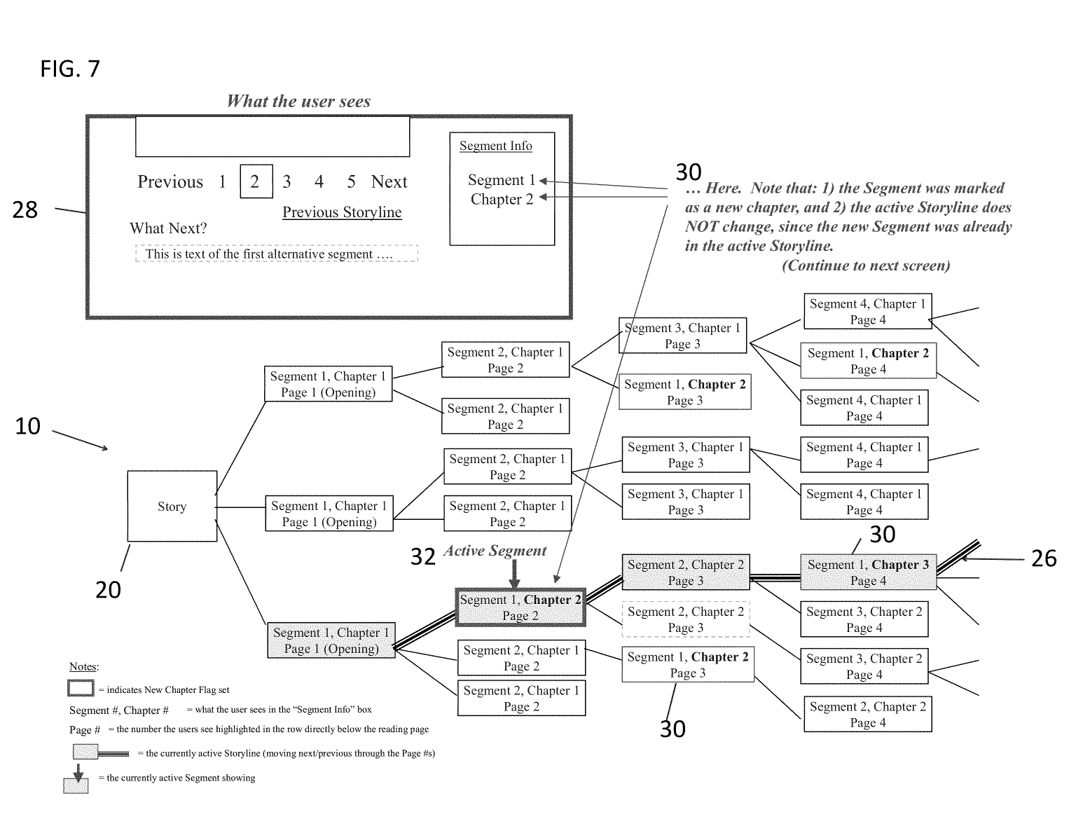

FIG. 7 illustrates that in system 10 any segment 22 may be marked by its contributor as beginning a new chapter 30 in the story. Thereafter, that segment will mark the beginning of the new chapter 30 in any storyline 26 in which that segment 22 is included by any user of the system 10.

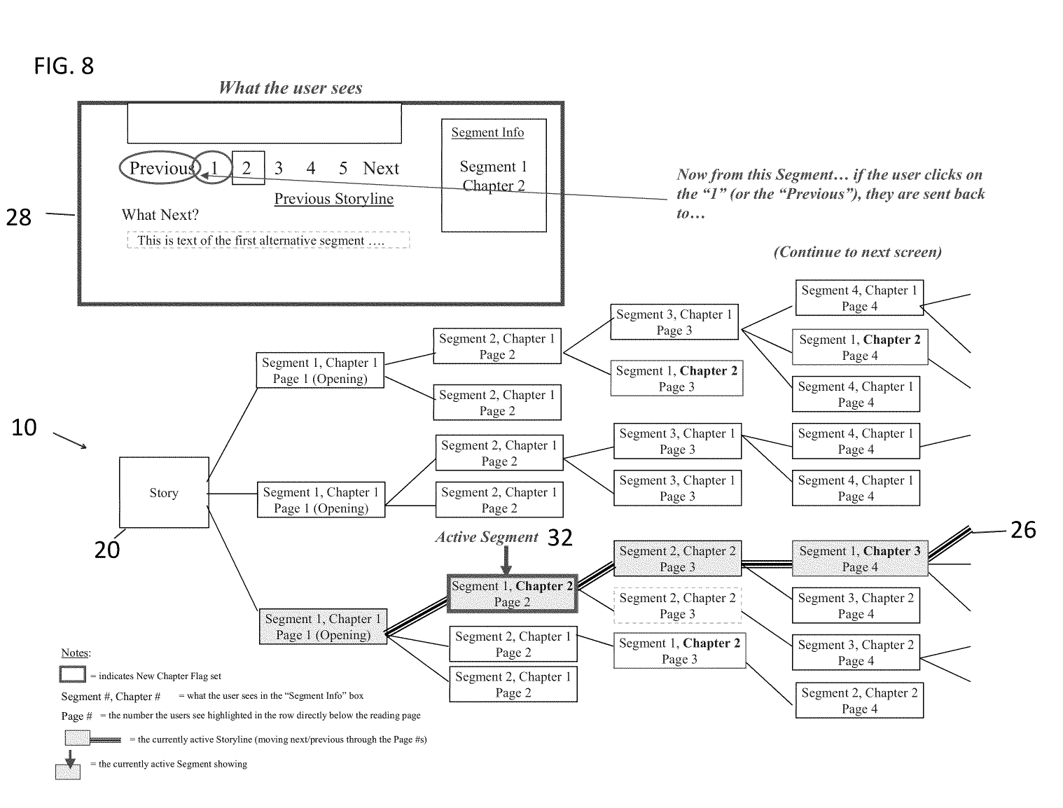

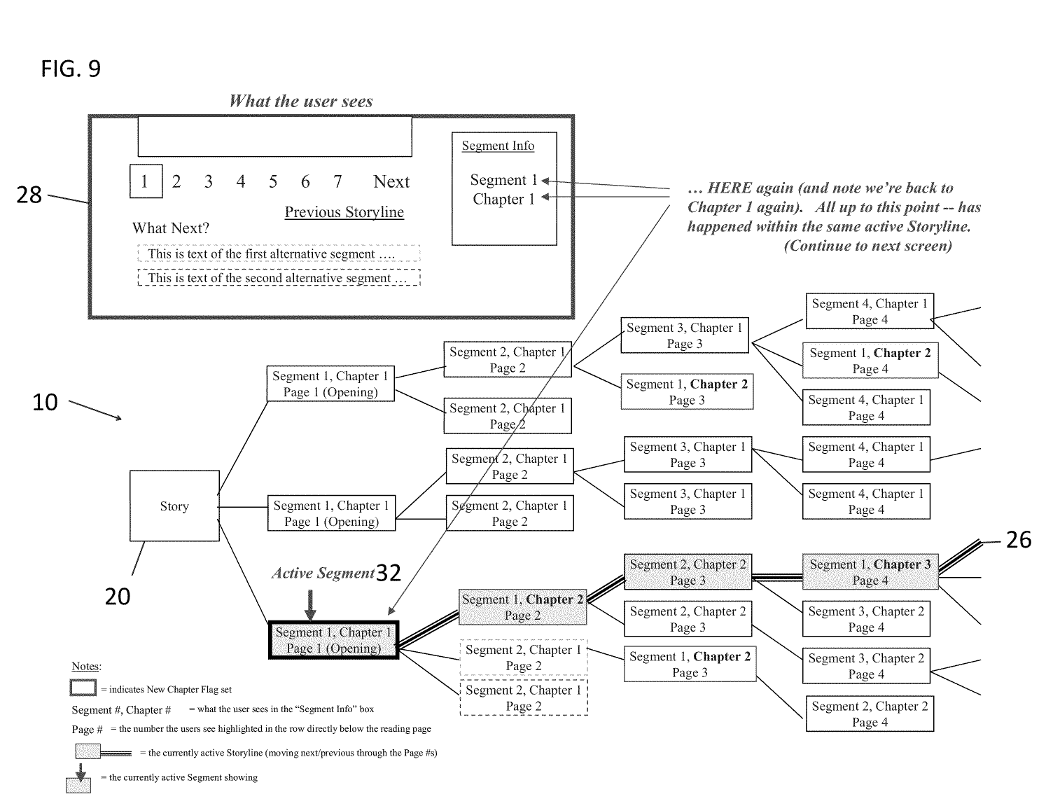

FIG. 8 and FIG. 9 illustrate how a user may use system 10 to step forward and backward through the segments 22 in the active storyline 26 to change which of the segments is the “active segment” 32.

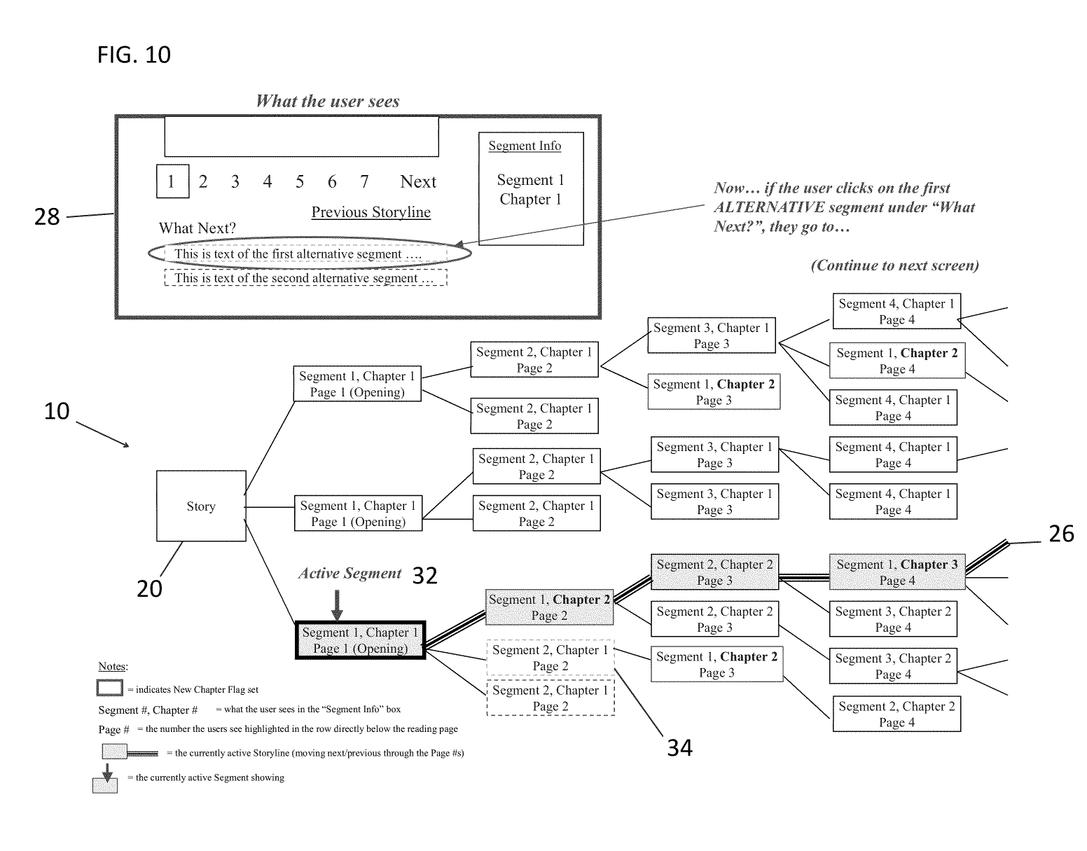

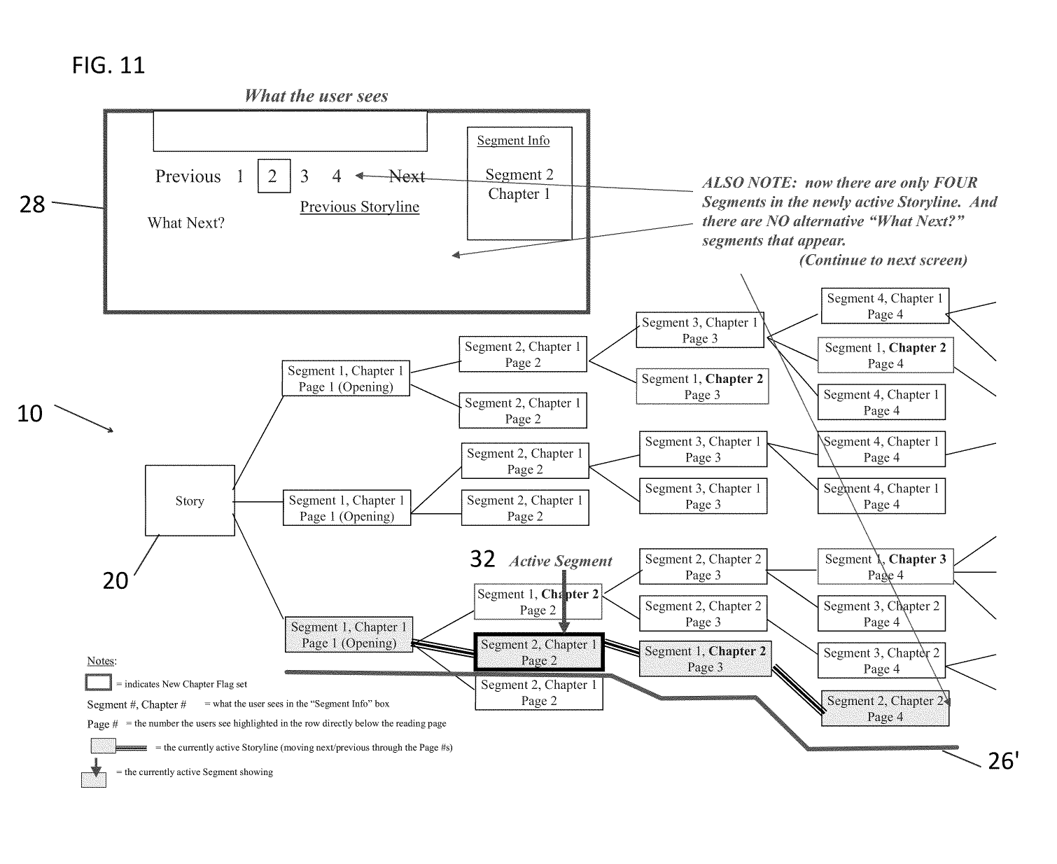

FIG. 10 and FIG. 11 illustrate how a user may use system 10 to move from a current storyline 26 (FIG. 10) to a new active storyline 26′ (FIG. 11) by selecting, as the active segment 32 (FIG. 11), an available alternative “next segment” 34 (FIG. 10) that is not contained within the currently active storyline 26.

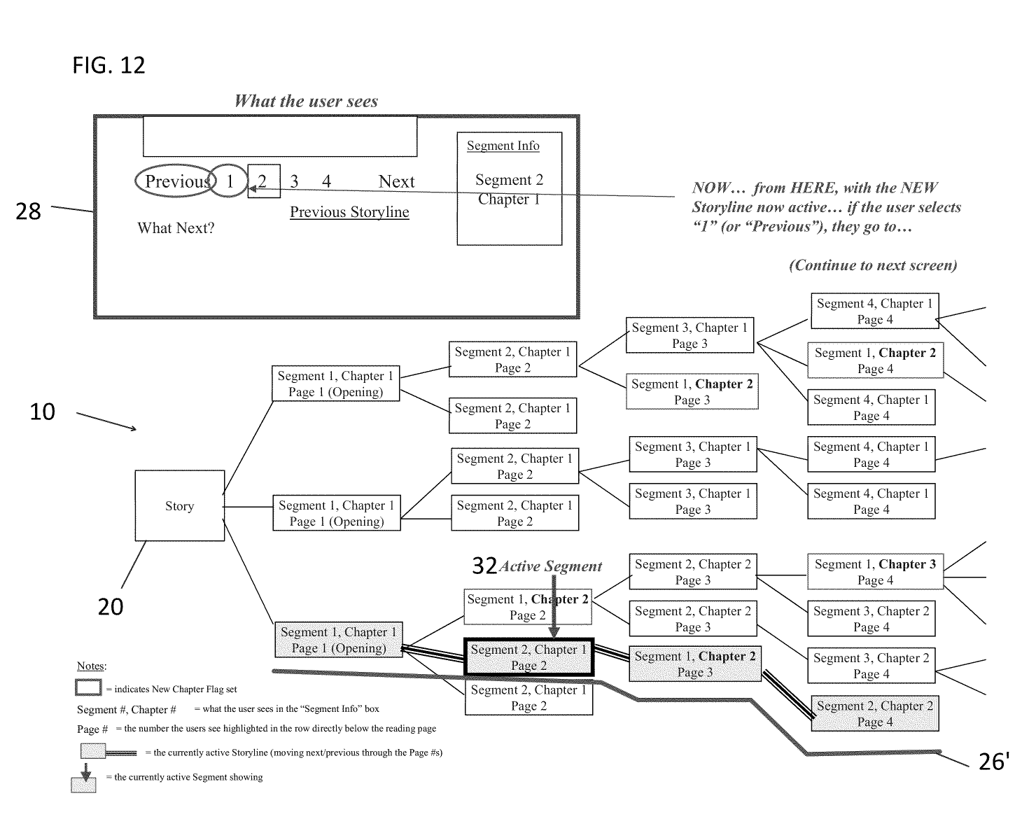

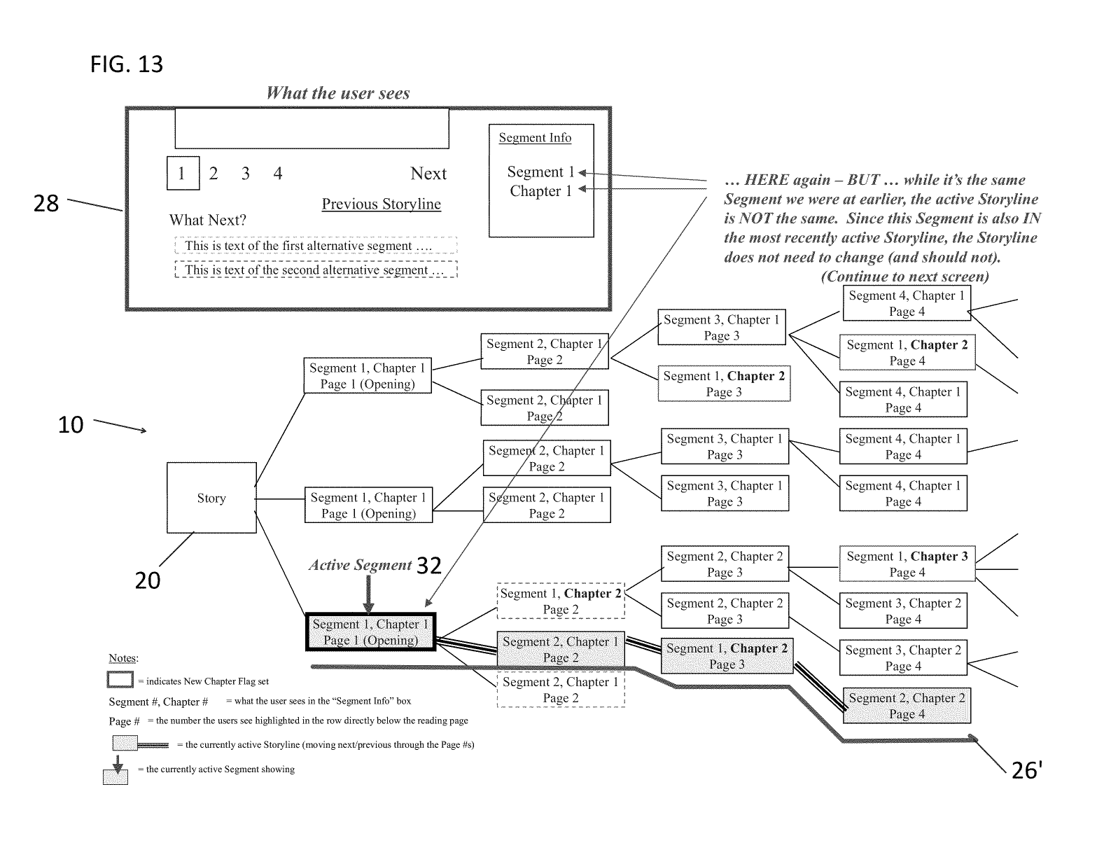

FIG. 12 and FIG. 13 illustrate, in comparison to FIG. 10, how in system 10, once a new storyline 26′ (FIGS. 12 and 13) has been made active by the user instead of a previous storyline 26 (FIG. 10), the user's forward and backward movement through the story will then move the user along the newly active storyline 26′, even upon reaching segments 22 that may be shared by both the new and the prior active storylines 26′, 26.

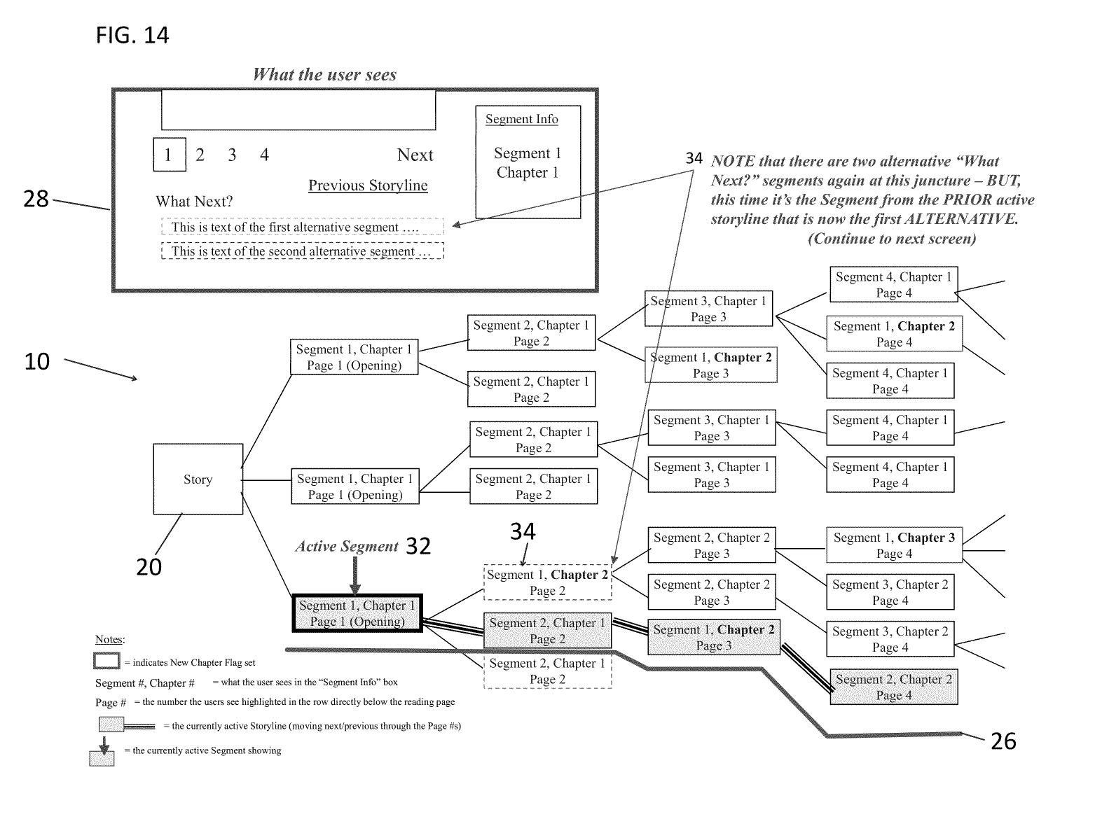

FIG. 14 illustrates, for example in relation to FIG. 1, that in system 10 for any active segment 32 shared by two or more unique storylines, only one of the available “next segment” or “child segment” 34 will be included in the currently active storyline 26. Any other available “next segments” 34 may be shown as alternatives and selected by the user as a means of exploring, or making active, a storyline different from that which is currently active.

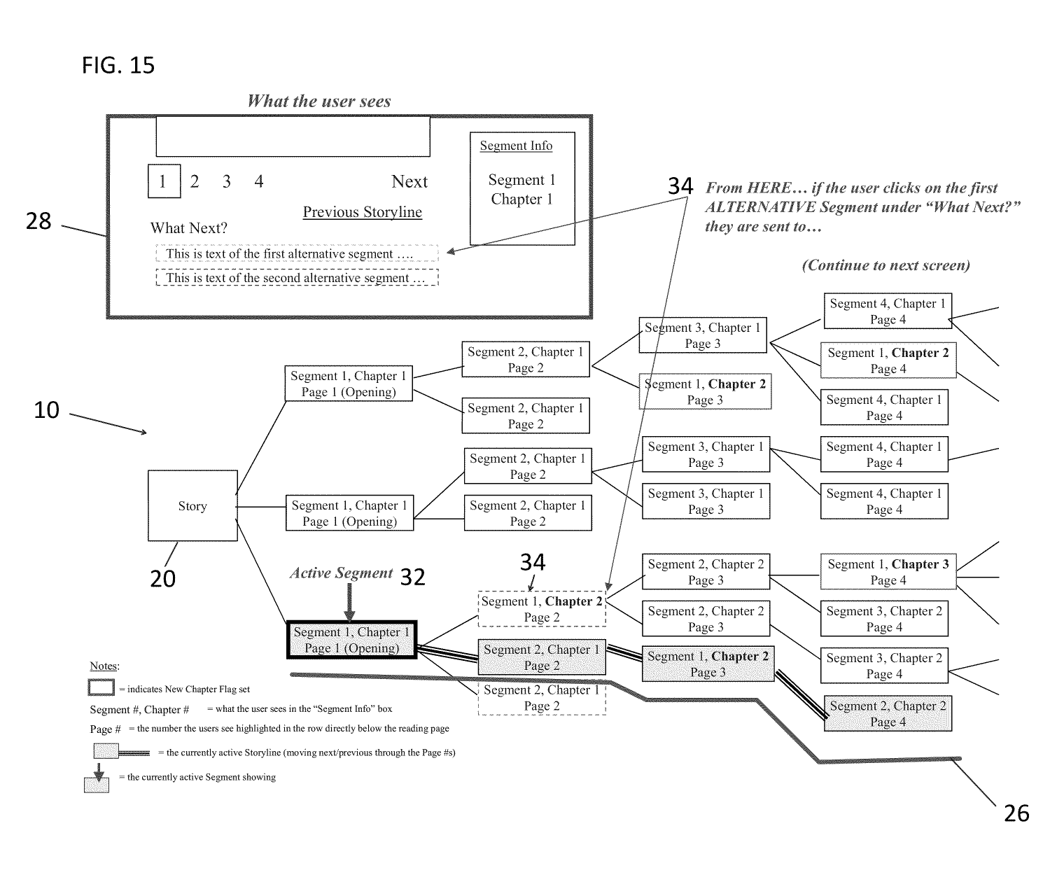

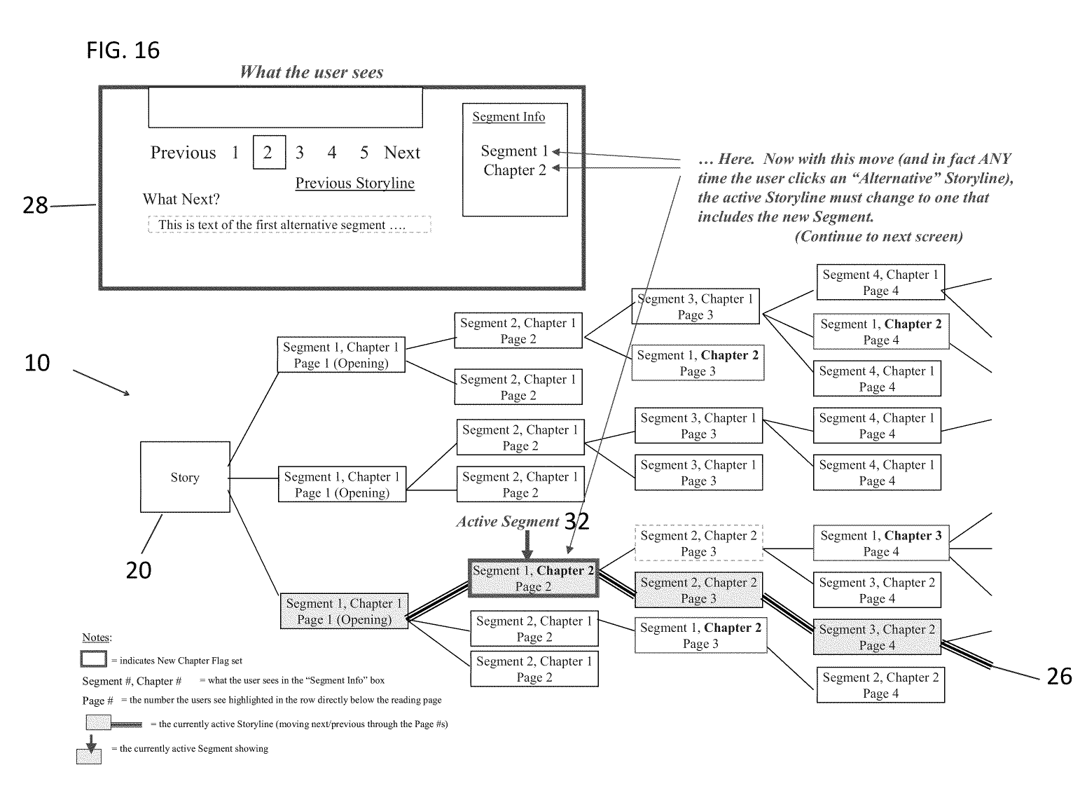

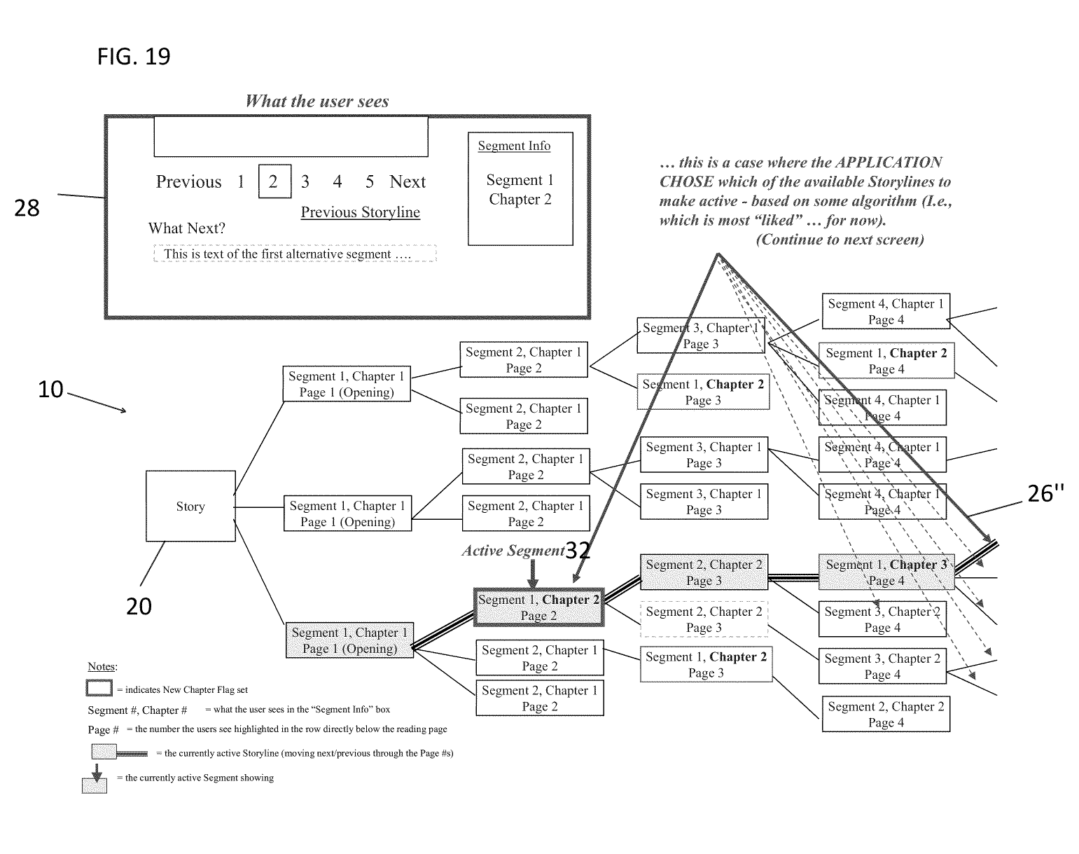

FIG. 15 through FIG. 19 illustrate, for example in relation to FIG. 10, that when a user uses system 10 to select an alternative “next segment” 34 (FIG. 15) that is not in the currently active storyline 26, but that may have been included in a prior active storyline, then the selected next segment 34 (FIG. 15) will be made as the new active segment 32 (FIG. 16, 17, 18, 19), but the prior active storyline 26 (FIG. 10) in which that segment had been included will not necessarily be made active. The system 10 may select a different unique storyline 26 to make active, so long as there are multiple storylines 26″ (FIG. 19) that include the newly selected segment 22 as the active segment 32.

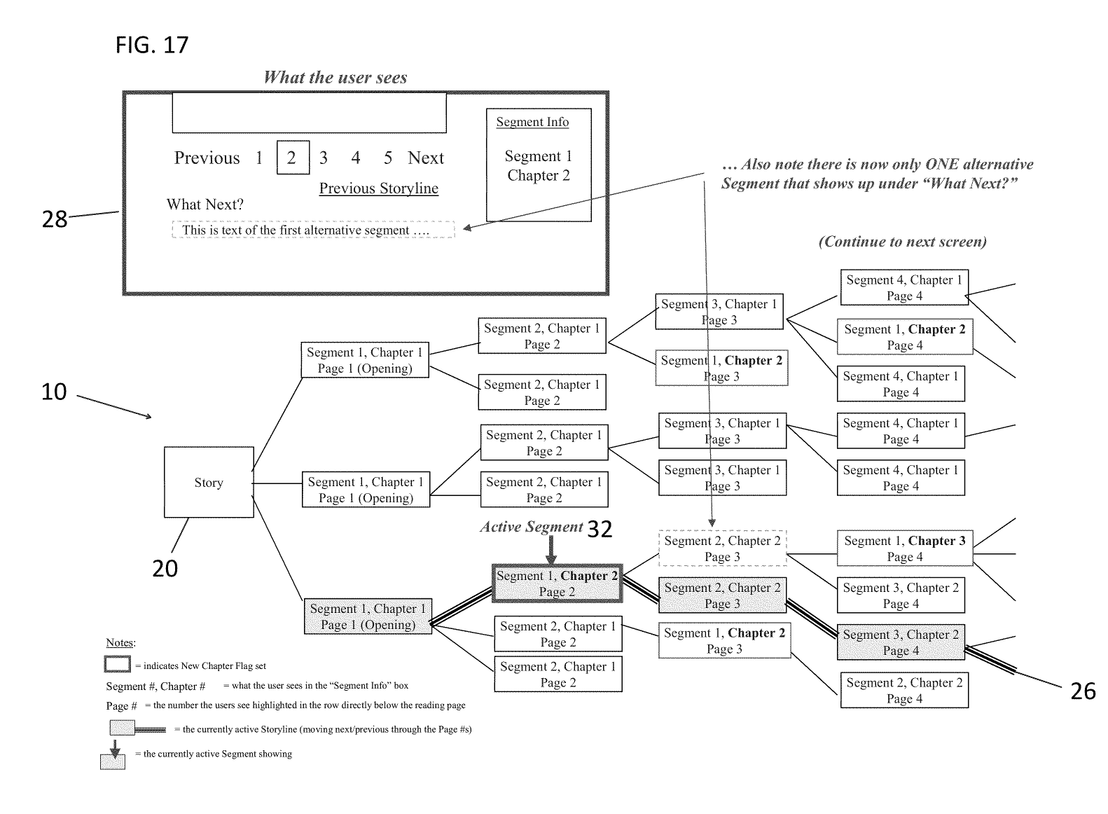

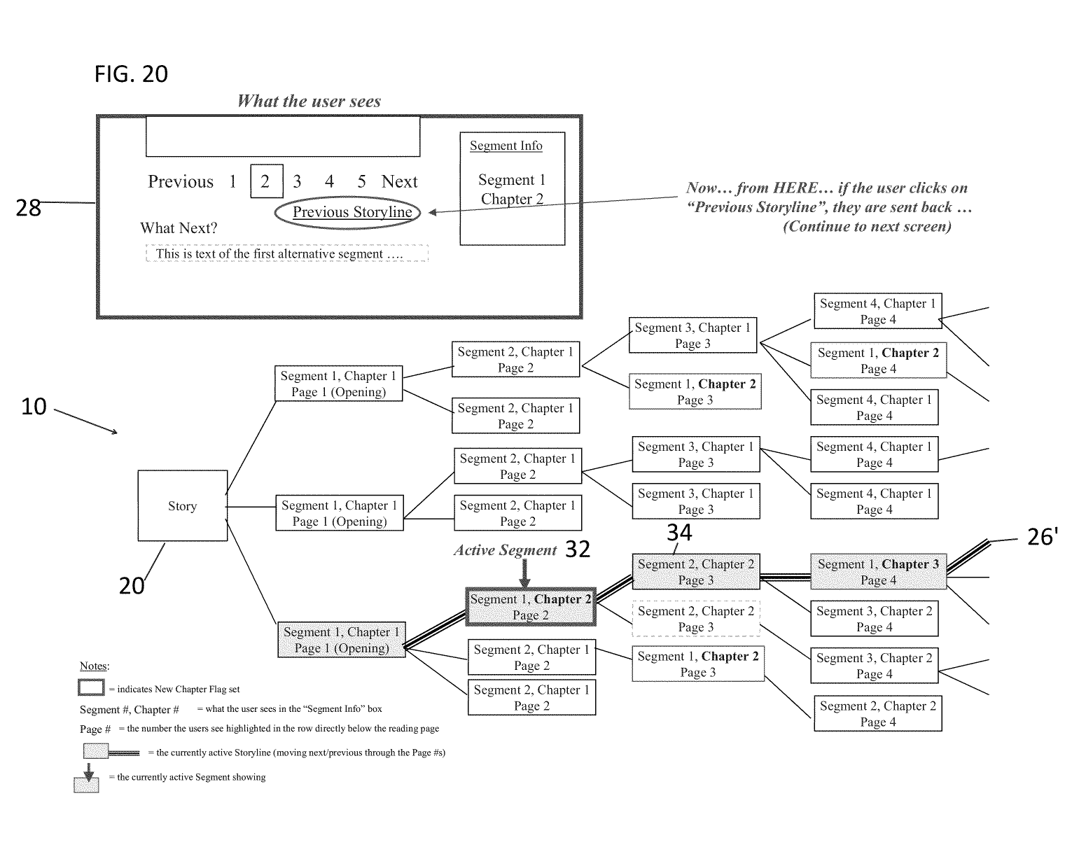

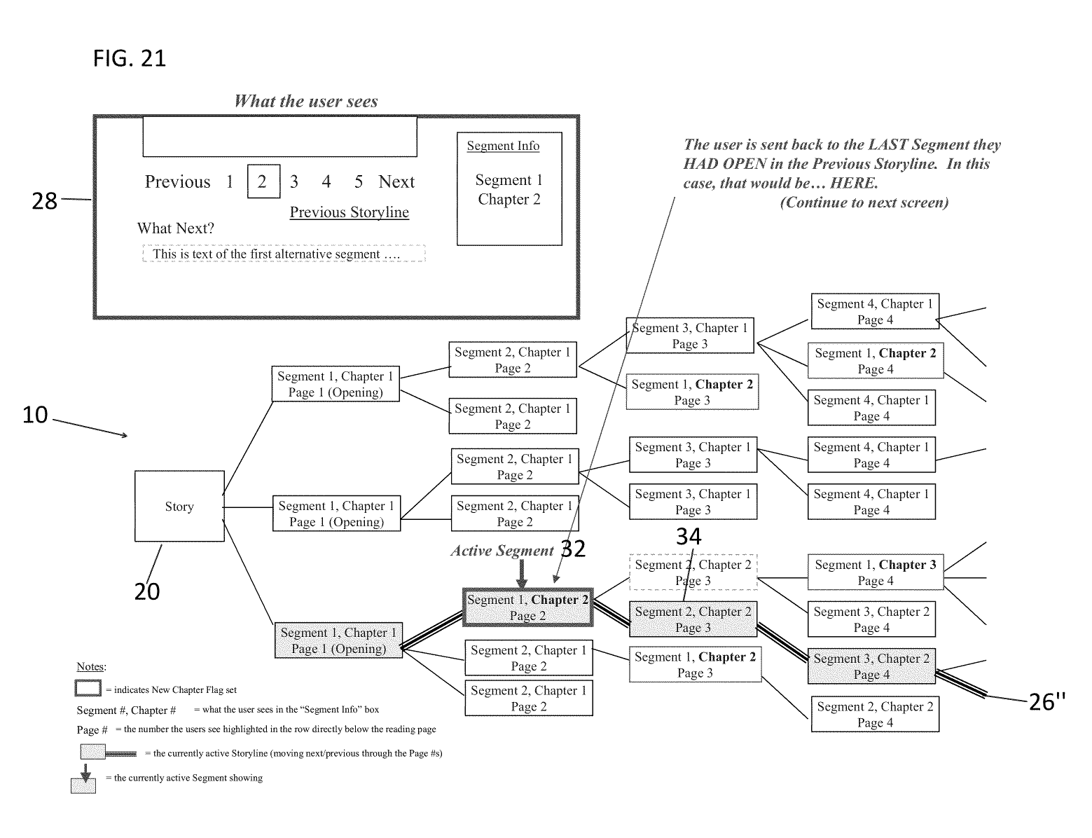

FIG. 20 and FIG. 21 illustrate, in comparison to FIG. 17, that system 10 allows a user to also choose to return from the currently active storyline 26′ (FIG. 20) to the prior active storyline 26 (FIG. 17), making it once again the currently active storyline 26″ (FIG. 21).

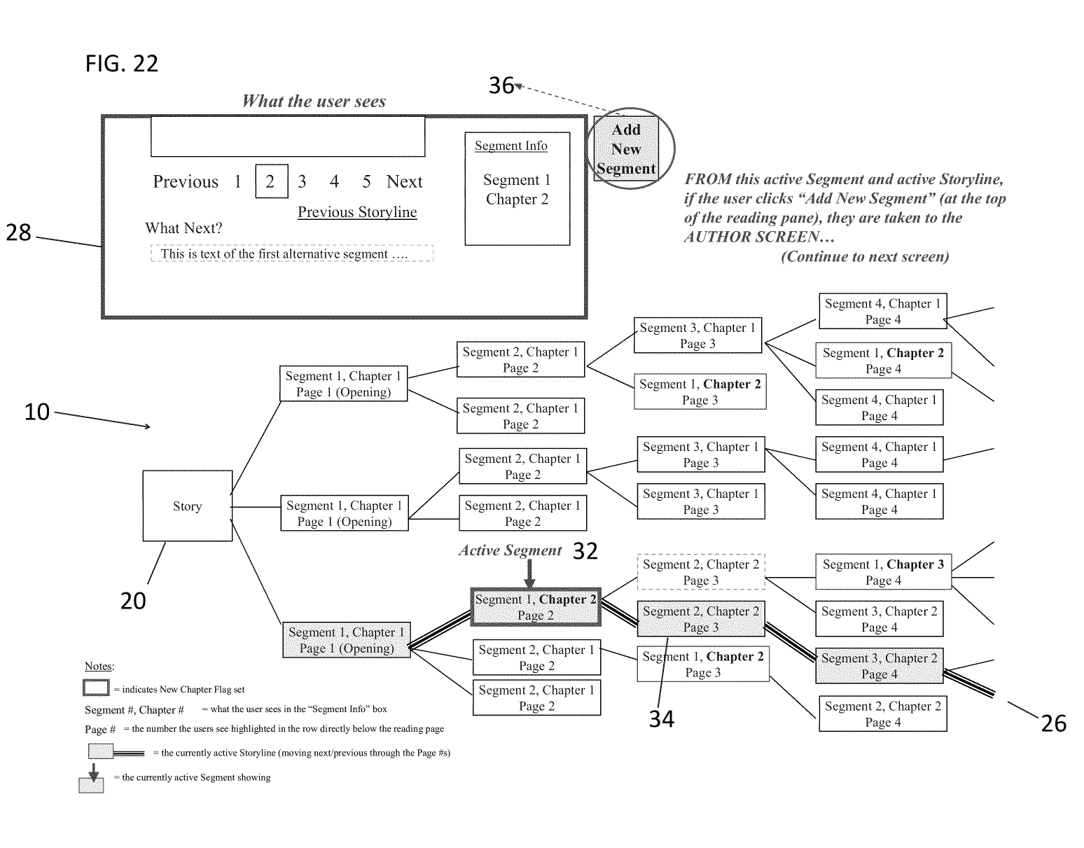

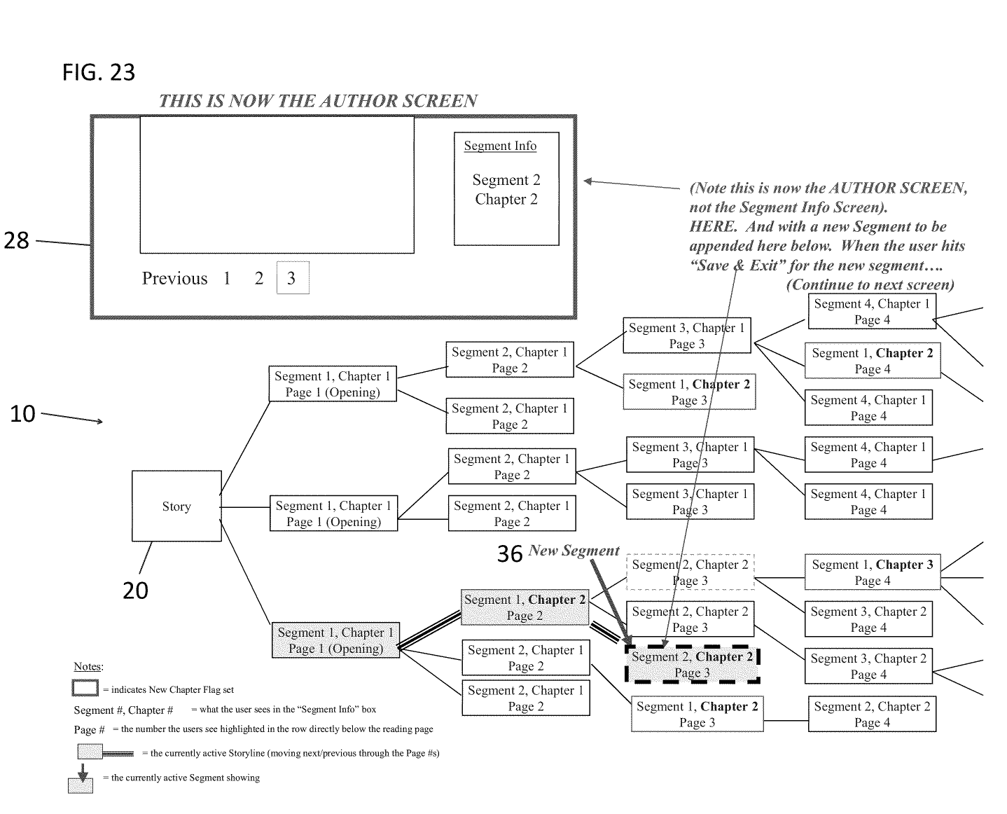

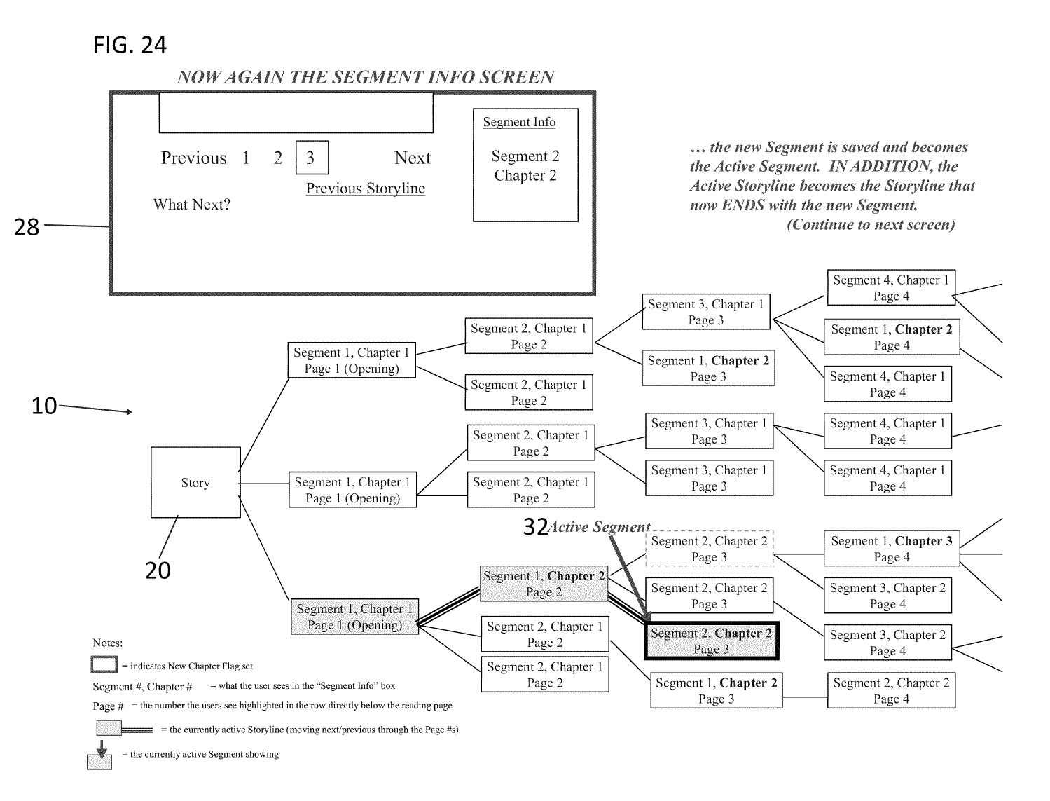

FIG. 22 through FIG. 24 illustrate how a user may use system 10, from any currently active segment 32 (FIG. 22), choose to append a new segment 36 (FIG. 23) of their own contribution and, once saved, the newly contributed segment 36 is left as the active segment 32 (FIG. 24). FIG. 22 illustrates the system 10 before adding in the new segment 36, FIG. 23 illustrates the system during addition of the new segment, and FIG. 24 illustrates the system after addition of the new segment—where the new segment is now the active segment 32.

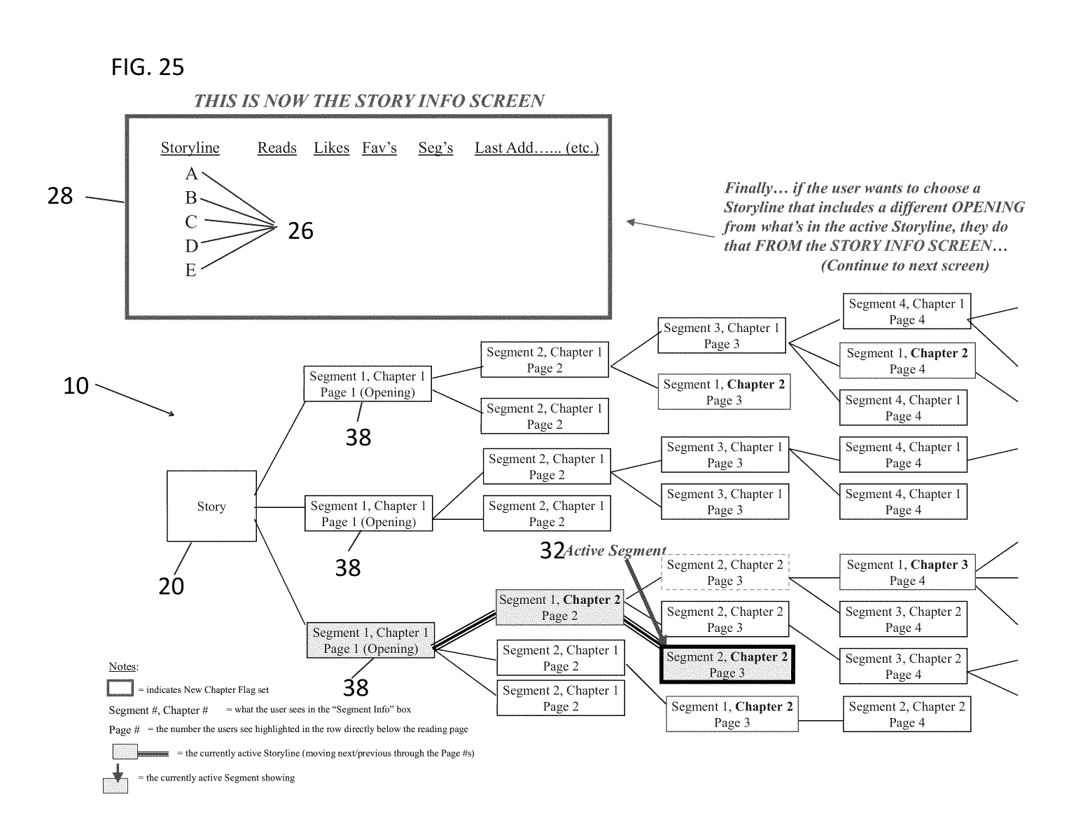

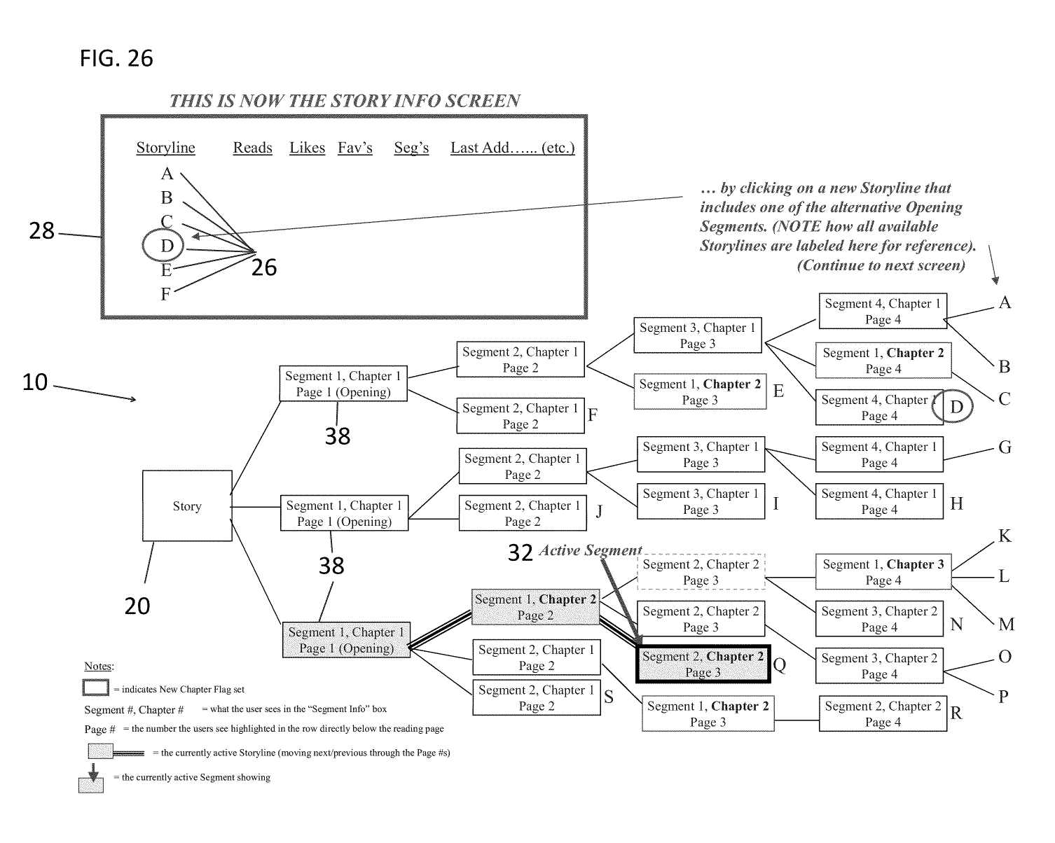

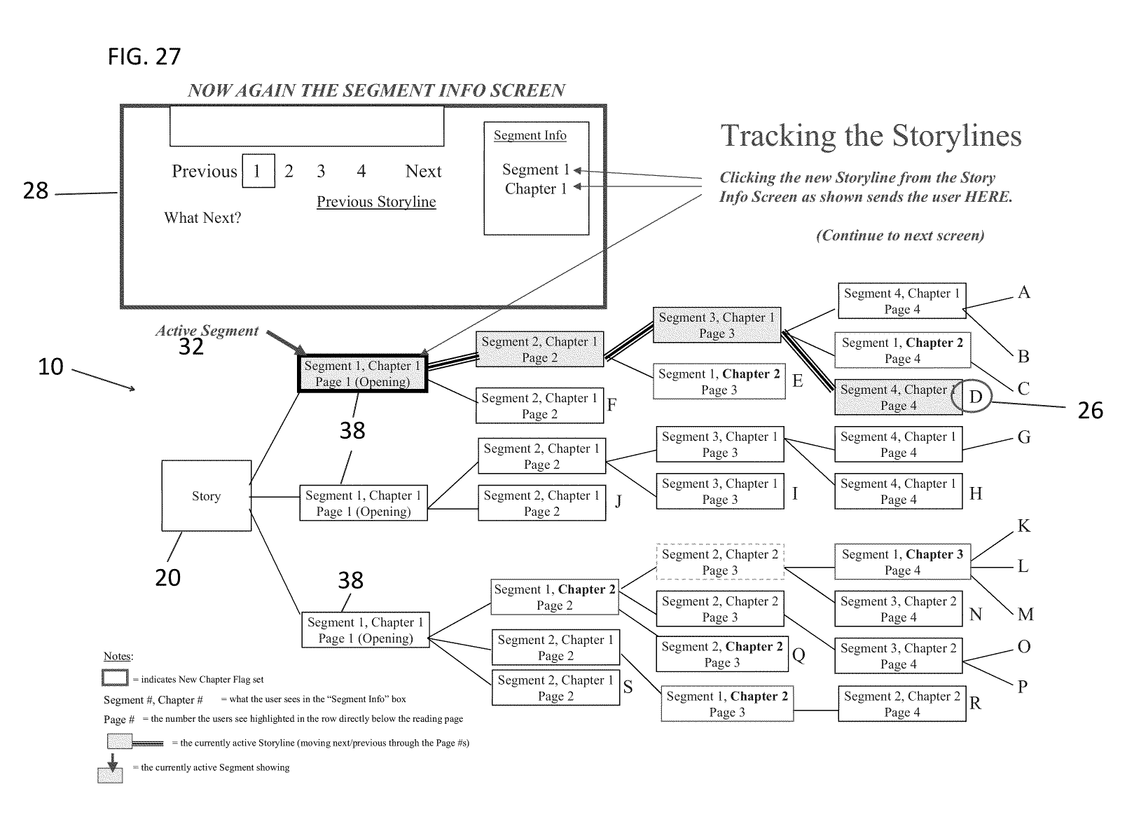

FIG. 25, FIG. 26 and FIG. 27 illustrate how a user may also use system 10 to create a new, and/or select from available existing, storylines 26 that do not share a common “opening segment” 38 with the currently active storyline; an opening segment being the first segment 22 in a storyline 26, and having no “parent segment.”

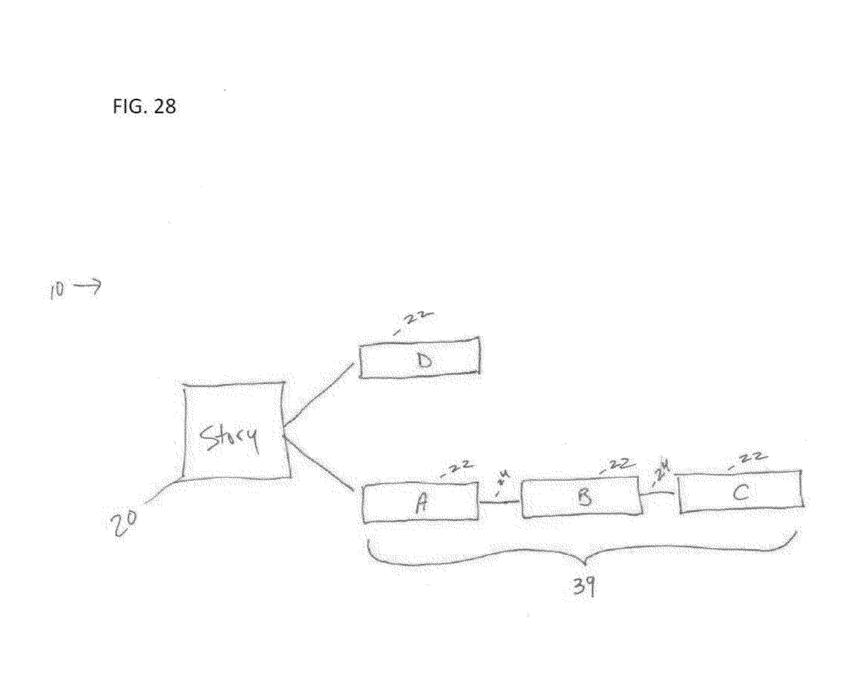

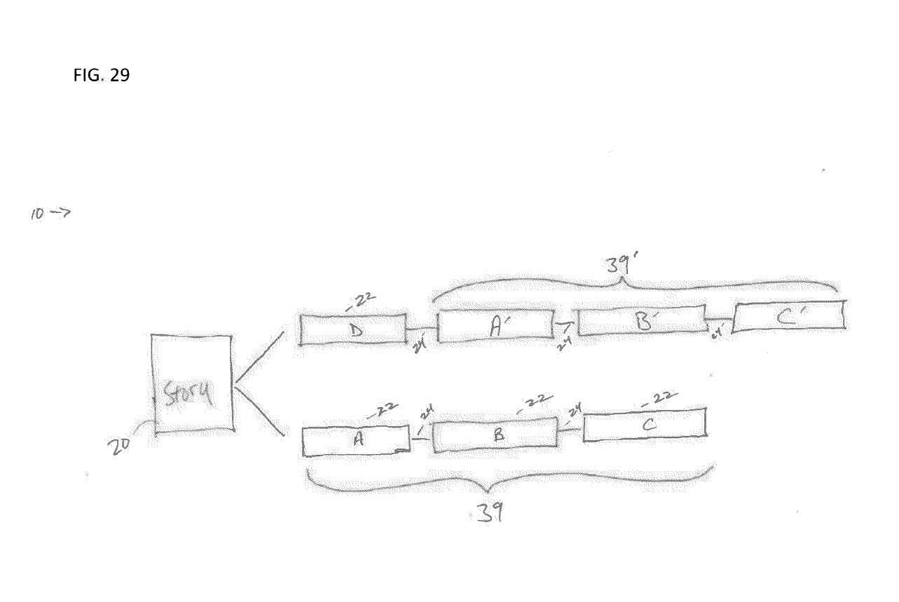

FIG. 28 and FIG. 29 illustrate how a user may replicate any segment 22, or any contiguous chain 39 of segments 22, into a story line other than the one in which the original segments 22, or chain 29, are located, creating a new copy of the segments or chain 39′ without disturbing or changing the original storyline, segments 22 or segment chain 39.

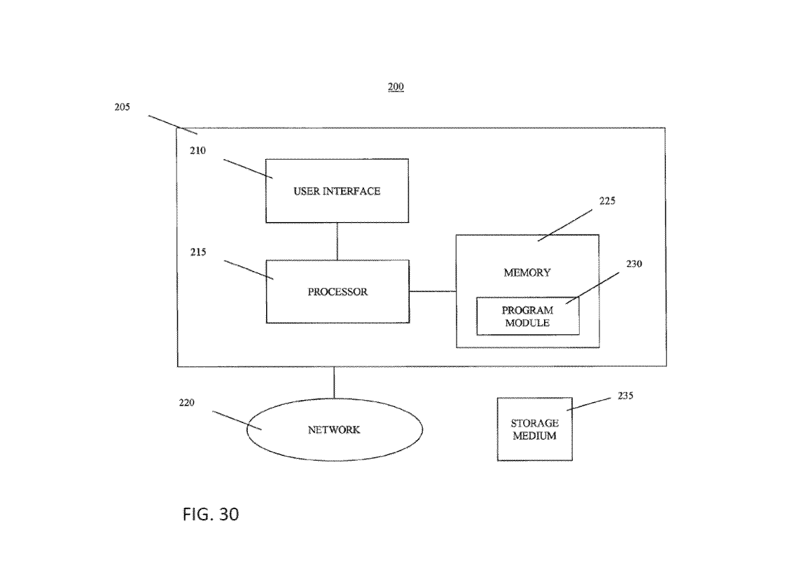

FIG. 30 is a block diagram of a system 200 that is programmed to operate the method and system 10 of FIGS. 1 through 29. Here, the system 200 includes a processor 215 such as a computer or server, a network 220 such as an intranet or the internet, and a plurality of user computers 240 (only one shown). The processor 215 is configured to allow communication via the network 220 among the users' computers 240 to implement the method of FIGS. 1 through 29.

More specifically, system 200 includes a computer 205 coupled to a data communications network, i.e. network 220, such as the Internet.

Computer 205 includes a user interface 210, processor 215, and a memory 225. Although computer 205 is represented herein as a standalone device, it is not limited to such, but instead can be coupled to other devices (not shown) in a distributed processing system.

User interface 210 includes an input device, such as a keyboard or speech recognition subsystem (not shown), for enabling a user to communicate information and command selections to processor 215. User interface 210 also includes an output device such as a display or a printer (not shown). A cursor control such as a mouse, track-ball, joy stick, or a touch-sensitive material situated on the display, allows the user to manipulate a cursor on the display for communicating additional information and command selections to processor 215.

Processor 215 is an electronic device configured of logic circuitry that responds to and executes instructions.

Memory 225 is a non-transitory computer-readable medium encoded with a computer program. In this regard, memory 225 stores data and instructions, which are readable and executable by processor 215 for controlling the operation of processor 215. Memory 225 may be implemented in a random access memory (RAM), a hard drive, a read only memory (ROM), or a combination thereof. One of the components of memory 225 is a program module 230.

Program module 230 contains instructions for controlling processor 215 to execute the systems and methods 10 described herein above. For example, under control of program module 230, processor 215 executes the processes of the systems and methods 10 of FIGS. 1 through 29. The term “module” is used herein to denote a functional operation that may be embodied either as a stand-alone component or as an integrated configuration of a plurality of sub-ordinate components. Thus, program module 230 may be implemented as a single module or as a plurality of modules that operate in cooperation with one another. Moreover, although program module 230 is described herein as being installed in memory 225, and therefore being implemented in software, it could be implemented in any of hardware (e.g., electronic circuitry), firmware, software, or a combination thereof.

While program module 230 is indicated as already loaded into memory 225, it may be configured on a separate storage medium 235 for subsequent loading into memory 225. Storage medium 235 is also a non-transitory computer-readable medium encoded with a computer program, and can be any conventional storage medium that stores program module 225 thereon in tangible form. Examples of storage medium 235 include a floppy disk, a compact disk, a magnetic tape, a read only memory, an optical storage media, universal serial bus (USB) flash drive, a digital versatile disc, or a zip drive. Storage medium 235 can also be a random access memory, or other type of electronic storage, located on a remote storage system and coupled to computer 205 via network 220.

The program module 230 on computer 205 can be accessed by a plurality of users via user computers 240 over network 220. Specifically, the users can use computers 240 to log into the program module 230 resident on computer 205 via network 220 in a known manner. It should be recognized that computer 205 can be any computing device such as but not limited to a home computer, a mobile computer (e.g., laptops, notebooks, ultrabooks, tablets, etc), smart phones, and other mobile or stationary computing devices.

The present disclosure is illustrated above by way of example having a centralized architecture, namely with the systems and methods 10 of FIGS. 1 through 29 being executed on computer 205 and being accessed by the user computers 240 via the network 220. Of course, it is contemplated by the present disclosure for the present disclosure to operate in a decentralized architecture, namely with one or more portions of the method of FIGS. 1 through 29 to be resident on the user computers 240 and with other portions of the method resident on computer 205.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the entire disclosure herein and any combinations of the individual embodiments disclosed herein.

What is claimed is:

1. A method for the creation, organization, consumption and distribution of bodies of user-generated content, comprising:
storing, in a computer, content generated by a plurality of users as separate segments; and
linking, via the computer, by the plurality of users the separate segments to one another to form one or more unique storylines through the separate segments.

2. The method of claim 1, wherein the content is generated synchronously or asynchronously to one another.

3. The method of claim 1, wherein the unique storylines are maintained, in the computer, as complete, distinct entries, and retain the separate segments without modification, deletion, obsolescence or replacement.

4. The method of claim 1, further comprising allowing the plurality of users to add, via the computer, a new segment of separate content.

5. The method of claim 4, wherein the new segment is a modified version of a prior existing separate segment.

6. The method of claim 1, further comprising capturing, via the computer, meta-information about or related to at least one of the separate segments, the unique storyline, and the story.

7. The method of claim 1, further comprising tracking, via the computer, contributions made by the plurality of users in each of the separate segments, storylines, and stories.

8. The method of claim 1, further comprising collecting, via the computer, at least one of user reviews, ratings, and statistics related to one or more of the separate segments, storylines, and stories.

9. The method of claim 8, further comprising generating or evaluating, via the computer, a storyline based on at least one of the user reviews, ratings and statistics.

10. The method of claim 1, wherein the content is selected from the group consisting of stories, books, articles, music, lyrics, plays, slideshows, videos and movies.

11. The method of claim 1, further comprising allowing the user, via the computer, to establish a framework of story attributes and generating or identifying, via the computer, the stories, segments or storylines that meet the framework.

12. The method of claim 1, further comprising allowing, via the computer, the plurality of users to publish or otherwise derive value from the story.

13. A content generation system comprising:
a plurality of user-contributed segments of content stored in a memory; and
a user interface in communication with the memory, the user interface allowing a user to select links among the plurality of user-contributed segments to create, experience or use a unique storyline of the plurality of user-contributed segments.

14. The content generation system of claim 13, wherein the user's creation, experience or use of the unique storyline does not impair any other user's creation, experience or use of the unique storyline or of any other storyline.

15. The content generation system of claim 13, further comprising meta-data stored in the memory related to one or more of the plurality of user-contributed segments, the unique storyline, and the story, wherein the meta-data comprises elements selected from the group consisting of a title, an overview description, a genre categorization, a list of characters, a story statistics, and any combinations thereof.

16. The content generation system of claim 15, wherein the story statistics comprise a statistic selected from the group consisting of a number of times the content has been read, a number of times the content liked, a number of times the content marked as a favorite, a user rating, a user evaluation, an assigned value, and any combinations thereof.

17. The content generation system of claim 13, wherein the user interface is configured to allow the user to select any one of the plurality of user-contributed segments as an active segment.

18. The content generation system of claim 13, further comprising an active state display displayed to the user, the active state display illustrating information selected from the group consisting of the content, media elements of the content, meta-information associated with the content, navigation information to progress through the unique storyline, navigation information to select segments not on the unique storyline to create a new storyline.

19. The content generation system of claim 13, wherein the user interface is configured to allow the user to add a new user-contributed segment or modify an existing user-contributed segment.

20. The content generation system of claim 13, wherein the memory is configured to maintain, as a complete distinct entry, each segment without modification, deletion, obsolescence or replacement after generation of the new segment.

21. The content generation system of claim 13, wherein the memory is configured to maintain, as a complete distinct entry, each unique storyline without modification, deletion, obsolescence or replacement after generation of a new storyline.

22. The content generation system of claim 13, further comprising a processor in communication with a plurality of user computers via a network, the memory being resident on the processor and the user interface being associated with any one of the plurality of user computers.

23. The content generation system of claim 13, wherein the content is selected from the group consisting of stories, books, articles, music, lyrics, plays, slideshows, videos and movies.

24. The content generation system of claim 13, wherein the user interface is configured to allow the user to select any unique storyline as an active storyline.
